(19) United States
(12) Patent Application Publication
(10) Pub. No.: US 2004/0118527 A1
(43) Pub. Date: Jun. 24, 2004

(54) Curtain structure having light-pervious and light-impervious curtain clothes

(76) Inventor: Henry Lin, Taipei (TW)

Correspondence Address: TROXELL LAW OFFICE PLLC, SUITE 1404, 5205 LEESBURG PIKE, FALLS CHURCH, VA, 22041, US

(21) Appl. No.: 10/323,690

(22) Filed: Dec. 20, 2002

(51) Int. Cl. E06B 3/48

(52) U.S. Cl. 160/84.04

(57) ABSTRACT

The present invention relates to a curtain structure having light-pervious and light-impervious curtain clothes, which comprises an upper beam, and a curtain cloth bonding with the upper beam, wherein said curtain cloth is consisting of a light-pervious and light-impervious curtain clothes. The light-pervious and the light-impervious curtain clothes are controlled for moving up or down by two sets of lanyards. The curtain structure of the present invention could provide either sunshade or light-pervious effect by controlling the moving up or down action of the light-pervious and light-impervious curtain clothes.

### BACKGROUND OF THE INVENTION

(1) Field of the Present Invention

The present invention relates to a curtain structure having light-pervious and light-impervious curtain clothes, which comprises an upper beam, and a curtain cloth bonding with the upper beam, wherein said curtain cloth is consisting of a light-pervious and light-impervious curtain clothes. The light-pervious and the light-impervious curtain clothes are controlled for moving up or down by two sets of lanyards. The curtain structure of the present invention could provide either sunshade or light-pervious effect by controlling the moving up or down action of the light-pervious and light-impervious curtain clothes.

(2) Background of the Prior Art

Nowadays, the purpose of a curtain is to provide sunshade and privacy functions. As shown in FIG. 1, a conventional curtain 10 (Roman type curtain) comprises an upper beam 11 and a curtain cloth 12 which is connected and fixed with a bottom part of the upper beam 11. One end of the upper beam 11 is connected with a lanyard-actuating element 13. The lanyard-actuating element 13 is useful for passing a lanyard 14 through therein and a pendent end of the lanyard 14 is outside of the lanyard-actuating element 13 for being pulled by a user. Plural transverse sections 15 are sewing sutured on the curtain cloth 12 at equal distance. Two holes 16, 16 are provided in the sewing sutured part of the transverse sections 15 for passing the other end of the lanyard 14 through therein and fixing it on the bottom holes 16,16. Therefore the curtain cloth 12 could be scrolled up or down by pulling or releasing the lanyard 14.

Thereby, the curtain 12 provides a sunshade effect when the curtain 12 is scrolled down. Conversely, if a sunlight irradiation or an increase of indoor lightness is desired, the curtain 12 should be scrolled up. However, such a conventional curtain lacks of variation and does not conform to the modern requirement for seeking variation.

Under the above circumstances, the present inventors have solved the above disadvantages by the curtain structure having light-pervious and light-impervious curtain clothes of the present invention. The main subject of the present invention resides in a curtain structure having light-pervious and light-impervious curtain clothes, which comprises an upper beam, and a curtain cloth bonding with the upper beam, wherein said curtain cloth is consisting of a light-pervious and light-impervious curtain clothes. The light-pervious and the light-impervious curtain clothes are controlled for scrolling up or scrolling down by two sets of lanyards. The curtain structure of the present invention could provide either sunshade or light-pervious effect by controlling the scrolling up or down action of the light-pervious and light-impervious curtain clothes. Due to the curtain cloth used in the present invention is consisting of a light-pervious and light-impervious curtain clothes, indoor lightness varies with the control of the curtain structure of the present invention. It conforms to the modern requirement for seeking variation.

### BRIEF DESCRIPTION OF THE DRAWINGS

FIG. 1 shows a three-dimension picture of a conventional Roman type curtain.

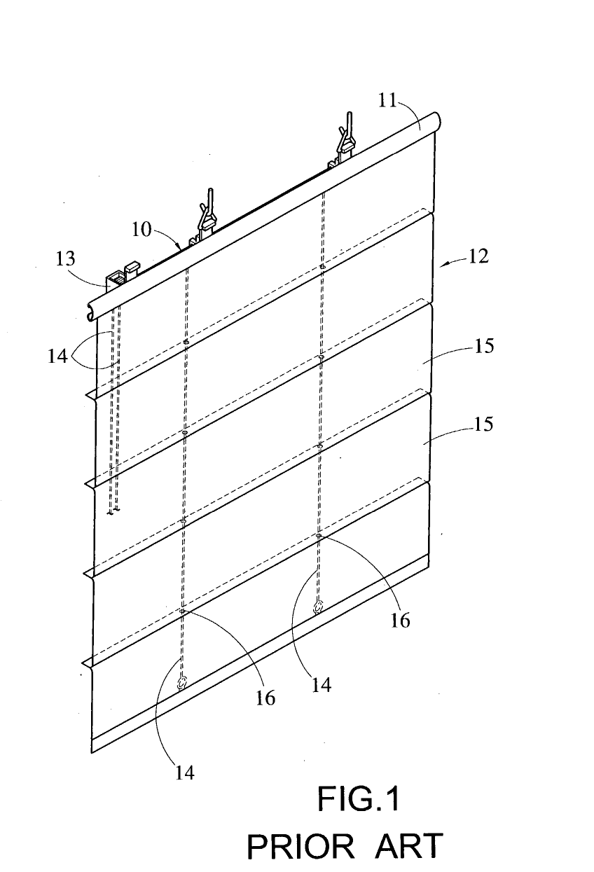

FIG. 2 shows a three-dimension picture of the curtain structure according to the present invention.

FIG. 3 shows a rear view of the curtain structure shown in FIG. 2.

FIG. 4 shows a three-dimension picture of the curtain structure according to the present invention in which a light-pervious clothes gathers together and a light-impervious clothes hangs down to provide a shade effect.

FIG. 5 shows a three-dimension picture of the curtain structure according to the present invention in which a light-impervious clothes gathers together and a light-pervious clothes hangs down to allow slight sunlight irradiation.

### DETAILED DESCRIPTION OF PREFERRED EMBODIMENT

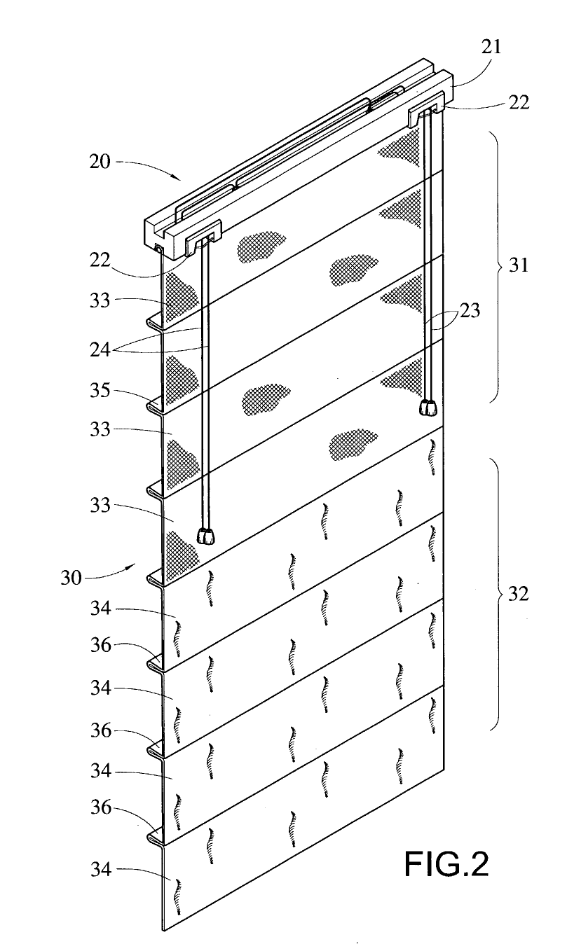

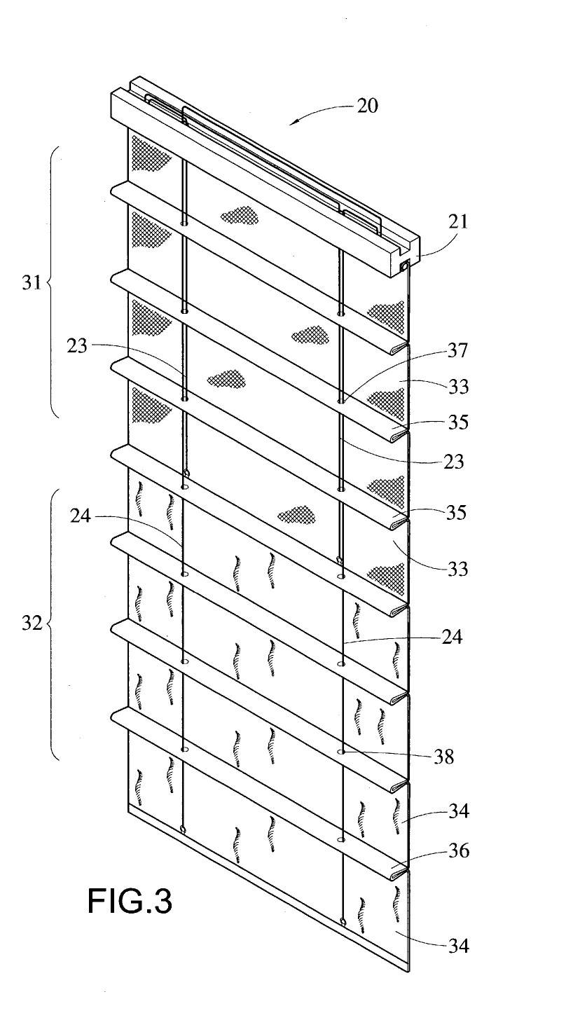

Please refer to FIGS. 2 and 3, the curtain structure 20 of the present invention comprises an upper beam 21 in which two lanyard-actuating elements 22, 22 are provided and a curtain cloth 30 bonding with the bottom part of the upper beam 21. The both lanyard-actuating elements 22,22 are useful for passing two sets lanyards 23, 24 through therein. These lanyards 23, 24 posses different functions. One end of the lanyards 23, 24 are separately pendent outside of each lanyard-actuating element 22 so that the curtain cloth 30 could be moved up or down by pulling or releasing the lanyards 23, 24.

The curtain cloth 30 is consisting of two kinds of clothes, in which a light-pervious clothes 31 (e.g. a yarn clothes) constitutes the upper part of the curtain cloth 30 and a light-impervious clothes 32 constitutes the lower part of the curtain cloth 30. Plural transverse sections 33, 34 are sewing sutured on the light-pervious clothes 31 and the light-impervious clothes 32 at equal distance, respectively. Two holes 37, 38 are provided in the sewing sutured parts 35, 36 of the transverse sections 33, 34 so that the lanyard 23 passes through the hole 37 and the lanyard 24 passes through the holes 37 and 38. Therefore the light-pervious clothes 31 and the light-impervious clothes 32 could be moved up or down by pulling or releasing the lanyards 23, 24.

The lanyard 23 passes through the hole 37 provided on the light-pervious clothes 31 and its one end fixes on the bottom section 33 of the light-pervious clothes 31 so that the light-pervious clothes 31 could be moved up or down by pulling or releasing the lanyard 23.

The lanyard 24 passes through the holes 37, 38 provided on the light-pervious clothes 31 and the light-impervious clothes 32 and its one end fixes on the bottom section 34 of the light-impervious clothes 32. Therefore the light-impervious clothes 32 could be moved up or down by pulling or releasing the lanyard 24.

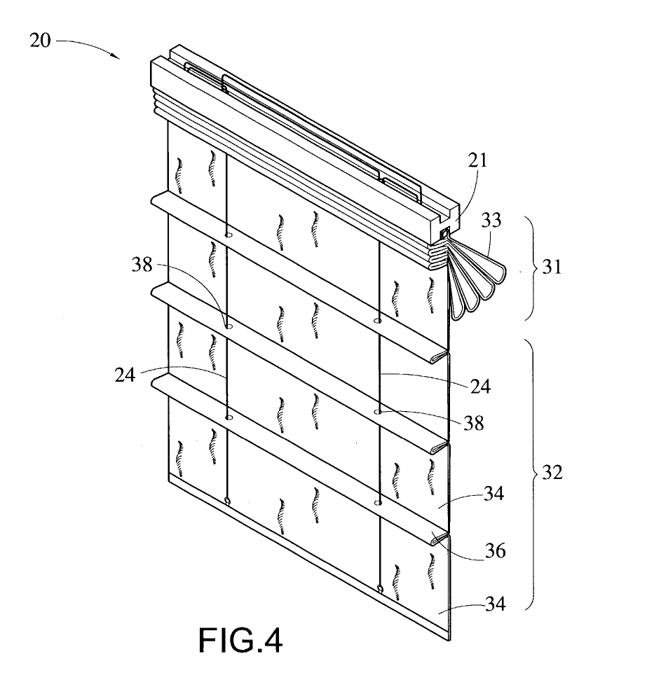

The light-pervious clothes 31 could either be moved up then gathered together by pulling the lanyard 23 or moved down by releasing the lanyard 23. Thus, when the lanyard 23 is pulled, the curtain cloth 30 will be moved up, i.e. the bottom section 33 of the light-pervious clothes 31 will overlap each other to gather together, as shown in FIG. 4. Therefore, the gathered section 33 is positioned above the light-impervious clothes 32 and exhibits an esthetic appearance. The light-impervious clothes 32 move up as the light-pervious clothes 31 move up. At that time, the curtain cloth 30 of the present invention provides a shade effect.

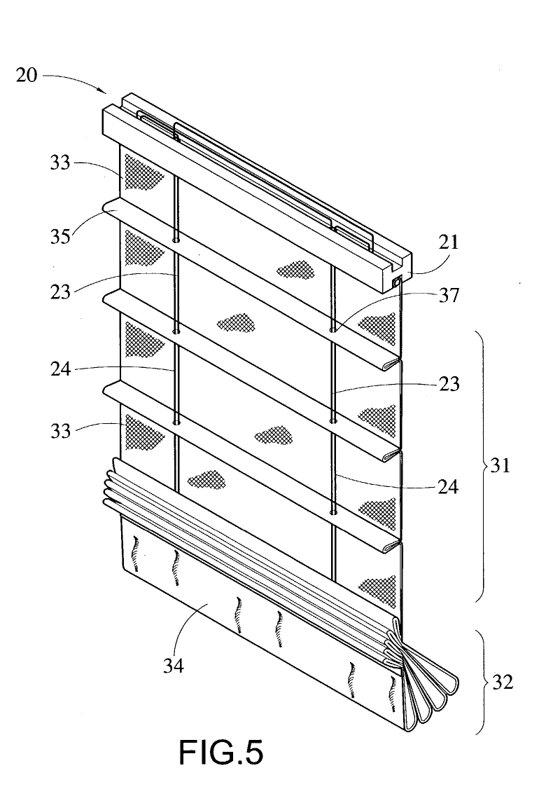

If a slight lightness is desired, the lanyard 23 could be released then the light-pervious clothes 31 will move up to allow sunlight irradiation. Subsequently, the light-impervious clothes 32 will overlap each other to gather together by pulling the lanyard 24, as shown in FIG. 5. At that time, the gathered section 34 is positioned at the bottom of the light-impervious clothes 31 and exhibits an esthetic appearance.

In summary, the curtain structure 20 of the present invention is characterized by comprising a curtain cloth 30 consisting of two kinds of clothes. A light-pervious clothes 31 constitutes the upper part of the curtain cloth 30 and a light-impervious clothes 32 constitutes the lower part of the curtain cloth 30. Therefore, when the light-pervious clothes 31 moves up and gathers together, the light-impervious clothes 32 also moves up to provide a shade effect. When the light-pervious clothes 31 moves and hangs down, the curtain cloth 30 allows slight sunlight irradiation. Therefore, due to the curtain cloth used in the present invention is consisting of a light-pervious and light-impervious curtain clothes, indoor lightness varies with the control of the curtain structure of the present invention. It conforms to the modern requirement for seeking variation.

Although the present invention has been described by the above embodiment, the present invention is not limited by the embodiment. Person skilled in the art would make various changes or modification without departing from the spirit and the scope of the present invention. The present invention is only limited by the appended claims.

What is claimed is:

1. A curtain structure having light-pervious and light-impervious curtain clothes, which comprises:
an upper beam, which is provided with a lanyard-actuating element for passing a lanyard through therein, thereby one end of the lanyard hangs down outsides of the lanyard-actuating element for being pulled by a user; and
a curtain cloth consisting of a light-pervious clothes and a light-impervious clothes, thereby either the light-pervious clothes or the light-impervious clothes moves up or down to provide either a shade effect or a lighting effect.

2. The curtain structure having light-pervious and light-impervious curtain clothes according to claim 1, wherein the light-pervious clothes is a yarn clothes to allow sunlight irradiation.

3. The curtain structure having light-pervious and light-impervious curtain clothes according to claim 1, wherein plural transverse sections are sewing sutured on the light-pervious clothes and the light-impervious clothes, and a hole is provided in the sewing sutured parts of the transverse sections for passing the lanyard through therein, thereby the light-pervious and the light-impervious clothes could be moved up or down by pulling or releasing the lanyard.

4. The curtain structure having light-pervious and light-impervious curtain clothes according to claim 1, in which when the light-pervious clothes moves up and gathers together, the light-impervious clothes also moves up to provide a shade effect, and the gathered section is positioned above the light-pervious clothes and exhibits an esthetic appearance.

5. The curtain structure having light-pervious and light-impervious curtain clothes according to claim 1, in which when the light-pervious clothes moves and hangs down allow sunlight irradiation, and the light-impervious clothes moves up and gathers together by pulling the lanyard thereby the gathered section is positioned at the bottom of the light-pervious clothes and exhibits an esthetic appearance.

6. The curtain structure having light-pervious and light-impervious curtain clothes according to claim 3, wherein two lanyard-actuating elements are provided in the upper beam for passing two sets lanyards through therein, one end of one set lanyard is fixed at the bottom of the light-pervious curtain clothes for controlling the light-pervious curtain clothes moving up or down, and one end of another set lanyard is fixed at the bottom of the light-impervious curtain clothes for controlling the light-impervious curtain clothes moving up or down.
